(19) United States
(12) Patent Application Publication
(10) Pub. No.: US 2003/0016385 A1
(43) Pub. Date: Jan. 23, 2003

(54) Data relay apparatus

(75) Inventors: Yoshinobu Matsumoto, Nagano-ken (JP); Masaaki Hanaoka, Nagano-ken (JP); Shogo Ogasawara, Tokyo (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/178,591

(22) Filed: Jun. 25, 2002

(30) Foreign Application Priority Data
Jun. 26, 2001 (JP) 2001-192730(P)

(51) Int. Cl. B41J 1/00; G06F 15/00

(52) U.S. Cl. 358/1.15

(57) ABSTRACT

The invention decreases the load of the security system in the relay of data through the network. The system is constructed with clients, servers, printers, and contents providers connected to the network. The client transmits a printing request to the server specifying contents to be printed. The server relays the contents to the specified printer and instructs the printer to execute printing. During the communication between each apparatus, the server can control the security according to the client individually. As a result, the overhead of data for the security can be decreased because the security does not need to be common to all clients, and the speed of the communication response can be enhanced.

### BACKGROUND OF THE INVENTION

1. Field of Invention

This invention relates to relaying data to an output device according to an instruction from a client, in a communication between the client and an output device connected to a network.

2. Description of Related Art

Various types of printers can be used as output devices for computers. Printers are connected to a computer through cables, such as two-way parallel interface (hereafter “Local connection”), and execute printing according to data received from the computer. It has recently become popular to share printers, that are connected to a network, with two or more computers that are also connected to the network as part of a LAN (Local Area Network).

In addition, the protocol referred to as IPP (Internet Printing Protocol) enables printing between an arbitrary client and a printer that is connected to the Internet. In this case, output resources are limited to the printers of which URI (Uniform Resource Indicator) is known. In other words, IPP cannot execute useful printing in which output resources are freely selected on the network.

The connection between the printer and the computer was usually fixed in conventional printing. In other words, printing is usually executed by using printers corresponding to each owner of the computer.

On the other hand, access to information without regard to place has become possible in recent years, as the information infrastructure, like the Internet, has become enhanced, and the information terminal to access the information infrastructure, such as notebook computers and cellular phones, enhances its portability. A printing technology in which the user can freely select the output resources on the network is desired based on this tendency. For instance, an immediate printing, in which information can be printed soon after its acquisition by using the nearest printer, is desired.

Thus, it is a practical problem to be solved that some security is required to prevent illegal accesses and data outflows when printers are expected to be freely selectable on the network.

However, providing this security increases the overhead for data transmission, because providing security to communications on the network requires that information for security be added to the communicated data. Therefore, a problem exists that the data amount of the entire network increases, and the load of servers which processes security increases.

### SUMMARY OF THE INVENTION

This invention decreases the load of a system which provides security to data to be communicated.

To address at least part of the above-mentioned problem, this invention discloses a data relay apparatus which relays between a client and an output device connected to a network, and relays data to the output device according to an instruction by the client. The data relay apparatus includes: a security unit configured to provide security to each communication with plural external devices related to the relay; a memory configured to keep a relation between the client and an operation of the security unit; an identification unit configured to identify the client sending an access request to the data relay apparatus; and a controller configured to control the security based on the relation corresponding to the identified client.

The data relay apparatus refers to memory, which stores a relation between a security control to external device and a client, according to the client which sends access request, thereby controlling the security level. As a result, this invention controls the required security level. For instance, this invention can only provide security to the communication with one specified external device for a client of which the communicated data is not very confidential. This invention, on the other hand, can provide security to the communication with all external devices for a client of which the communicated data is highly confidential. This invention can decrease the load of each device and can enhance the response speed of the communication while maintaining the required security, because the security can be flexible to each communication. Security can be controlled, for example, by switching the on/off state according to each external device, or by adjusting the security level according to each external device. Moreover, these two operations can be combined.

In the data relay apparatus, the external device may include a data providing device configured to provide data at least responding to the request from the client.

The data providing device is a device which is connected with the network like the Internet, and offers various information according to requests from the client. The information includes various electronic information which can be communicated on the network, such as the weather forecast, the dictionary, E-mail and the invoice of a credit card. Security is required for some of these types of information, such as a business document and an individual deposit balance, which include a secret matter. Security is not required for other parts of these types of information, such as maps and restaurant information. The data relay apparatus provides an advantage that the security is controllable according to the client in the communication with such a data providing device.

In the data relay apparatus, the external device might include at least a data conversion device configured to convert the data into another data format.

The data conversion device is a device which converts the format of input data into another format. For instance, when printers are expected to be used as output devices, the data conversion device inputs HTML (Hyper Text Markup Language) data and converts into PDF (Portable Document Format) data suitable for printing. The data relay apparatus provides an advantage that security can be controllable according to the client when communicating with such a data conversion device. The data format is not limited to HTML and PDF, and various other data formats are acceptable.

In the data relay apparatus, the security could be a prescribed encryption.

Various technologies, such as common key encryption and public key encryption, can be used for encryption. Providing such encryption to the communication with external device, the data relay apparatus provides an advantage that the data can be concealed even when an illegal access to the data is attempted.

In the data relay apparatus, the security can be an electronic certification.

Various applications are acceptable for the electric certification, such as the SSL method, which is one of standard certification methods on the Internet, and exchanging ID and the password. The data relay apparatus provides an advantage that can prevent or reduce illegal accesses during the communication with external devices.

This invention can cover various embodiments, such as a data relay method in addition to the data relay apparatus mentioned above. Moreover, this invention can be formed of a computer program which causes a computer to execute these methods. The computer program can be stored in a computer readable recording media, and can also be formed of a transmittable form through a network. Typical examples of the recording media include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

### BRIEF DESCRIPTION OF THE DRAWINGS

FIG. 1 is a schematic that shows the general structure of the print system of this embodiment;

FIG. 2 is a schematic that shows the data transfer during E-mail printing;

FIG. 3 is a chart that shows the processing during E-mail printing;

FIG. 4 is a schematic that shows the example of the use interface during E-mail printing;

FIG. 5 is a detailed schematic that shows the internal structure of the print portal; and

FIG. 6 is a chart that shows the processing of the security control, which is referred to as SSL (Secure Socket Layer) that is normally used in the Internet.

### DETAILED DESCRIPTION OF PREFERRED EMBODIMENTS

Various embodiments of this invention are disclosed below in the following order.

A. Apparatus structure:

B. Example of printing:

C. Internal structure:

A. Apparatus structure:

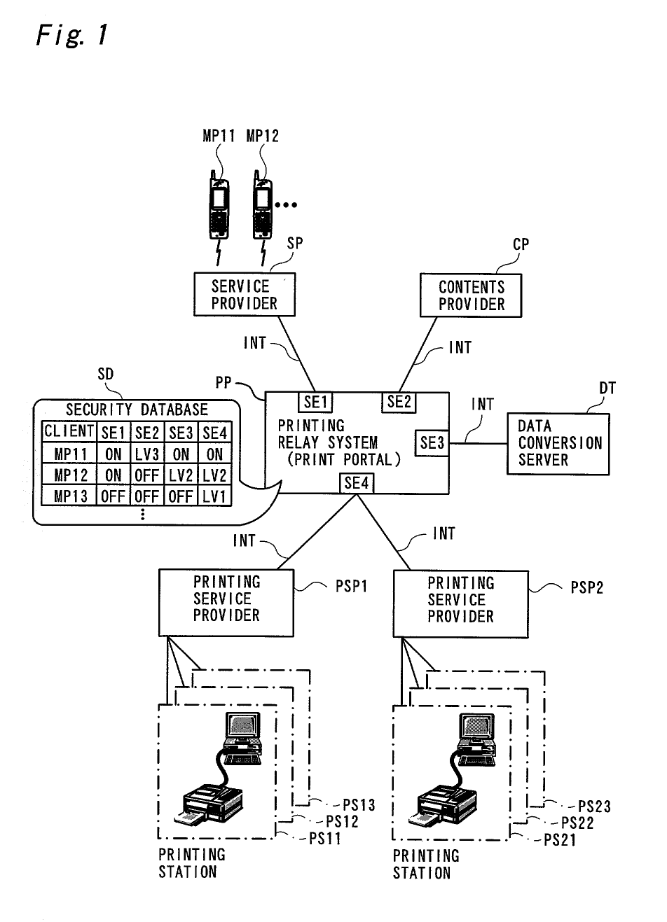

FIG. 1 is a schematic that shows the general structure of the print system of this embodiment. In this embodiment, the system which executes printing through the Internet is illustrated. A similar structure may be applicable to comparatively limited network environments, such as a LAN (Local Area Network) and a so-called personal computer communication.

In this embodiment, various servers and clients are connected with the Internet INT. This equipment can mutually transfer information through the Internet INT. Though a specific number of devices is shown here for convenience of explanation and illustrating, more devices can be connected. The embodiment executes printing by an arbitrary printer under the system configuration with which a lot of servers and clients are connected through the Internet INT like this.

In this embodiment, cellular phones MP11 and MP12, which have the access function to the Internet, are used as clients. These cellular phones MP11, etc., can access the Internet through a service provider SP. Not only cellular phones, but also Personal computers and various PDAs (Personal Digital Assistant), are also applicable as clients.

A contents provider CP is also connected with the internet INT. The contents provider CP provides contents to be printed in this embodiment. For example, a Web-page server on the Internet INT can be a contents provider.

In the embodiment, printing station PS11, etc., can be the output device. A printing station PS11, etc., is, for example, a system that can receive data through the Internet and execute printing. For instance, the printing station can be constructed with a computer connected with the Internet, and a printer locally connected with the computer. The printing station can be set in the place where the specific user can use the station, such as houses and offices, and can also be set in a public space, such as shops and hotels.

In the embodiment, printing is executed through sending contents received from the contents provider CP to the printing station according to the instruction by the client MP11 and such. In the embodiment, the printing relay system (print portal) PP and the printing service provider PSP1, PSP2 relays data between the client and the printing station.

The printing service provider PSP1, etc., manages the printing station PS11 and such. In the illustrated example, the printing service provider PSP1 manages the printing station PS11-PS14. The printing service provider PSP2 manages the printing station PS21-PS24. Assuming the printing station PS11, etc., are installed in the branches respectively, the printing service provider PSP1, etc., can be installed corresponding to each head company of the branches. For example, a company A manages the printing station PS11-PS14, installed in branches of the company A, through the printing service provider PSP1, and a company B manages the printing station PS21-PS24, installed in branches of the company B, through the printing service provider PSP2. This enables each company to respectively manage their own printing station, thereby adding a specific service peculiar to each of them on the charge and other respects for the relay of print data.

The print portal PP manages the printing service provider PSP1 and PSP2. Therefore, the print portal PP will indirectly manage the printing station PS11, etc., through the printing service provider PSP1 and PSP2. Even when the companies of the printing service provider PSP1 and PSP2 are different, the print portal PP can provide basic function common to these companies. For instance, when the client MP 11, etc., instructs the execution of printing, a common user interface can be provided to the user, such that the user's convenience can be enhanced.

The print portal PP is connected with the external devices, that is, the service provider SP, the contents provider CP, the data conversion server DT, and printing service provider PSP1 and PSP2, through security units SE1-SE4 in the print portal PP. The print portal PP controls the security unit by referring to the security database SD according to the client. When communicating with the external devices, the security unit can respectively control the switch on/off of the security and the security level.

The print portal PP and the printing service provider PSPl, etc., do not need to be constructed with a single server. They can be respectively provided by the distributed processing with two or more servers.

B. Example of printing:

Next, the printing through the print portal PP is disclosed by way of example of printing E-mail, such that the understanding of the function of each apparatus in this system can be facilitated.

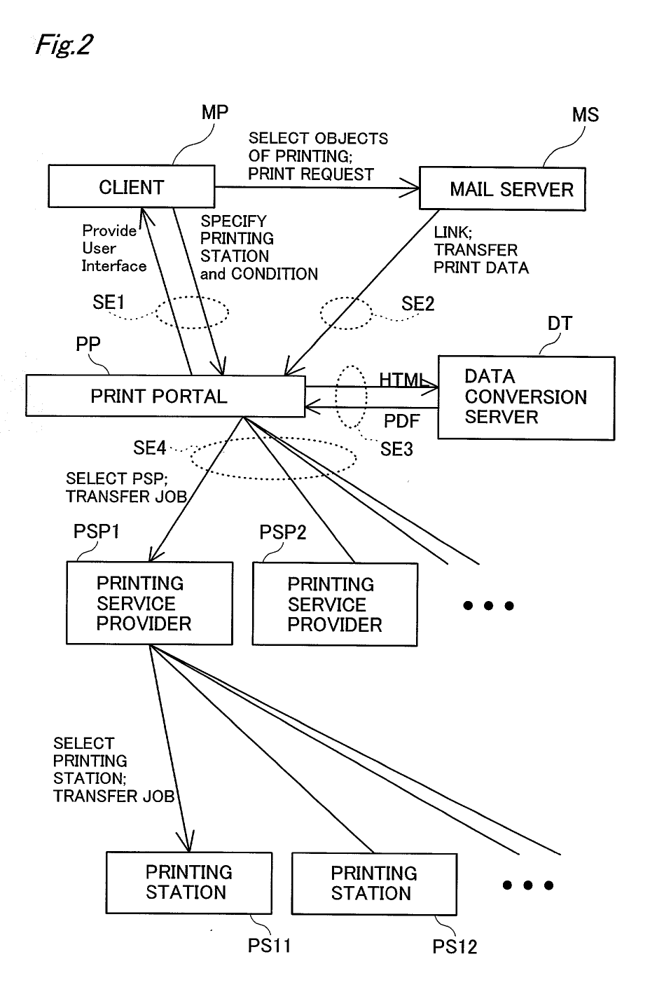

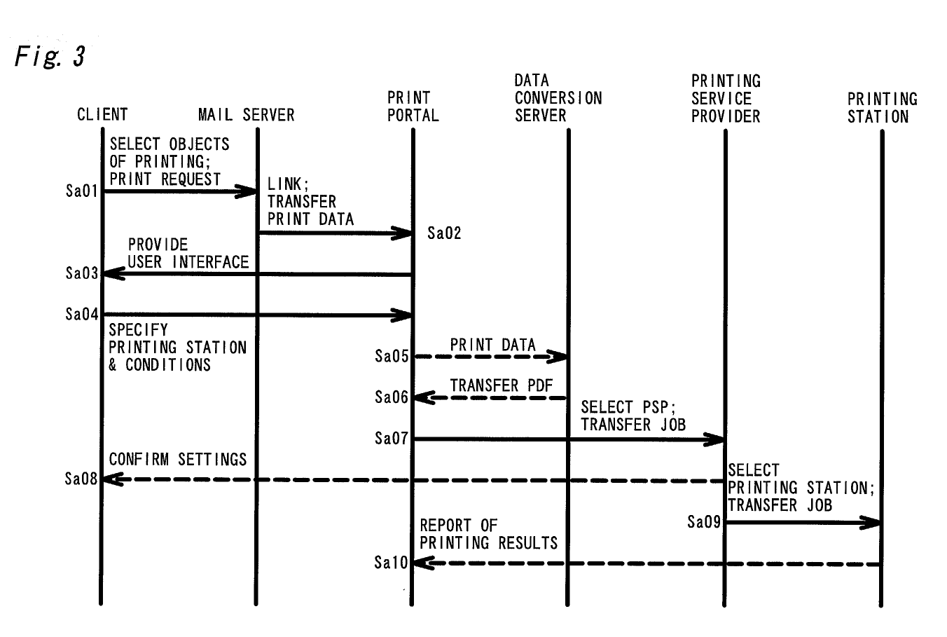

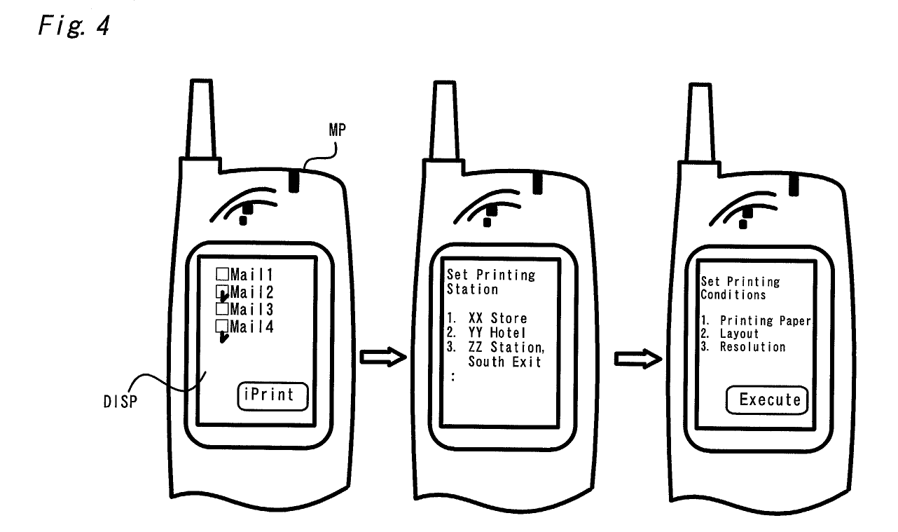

FIG. 2 is a schematic that shows the data transfer during E-mail printing. FIG. 3 is a chart that shows the processing during E-mail printing. FIG. 4 is a schematic that shows an example of using an interface during E-mail printing. The function of each unit is explained with referring to FIGS. 2-4. In this E-mail printing, the mail server MS corresponds to the contents provider.

A user accesses mail server MS, through the client MP, confirms E-mail to the user, and selects E-mail to be printed. In FIG. 4, a user interface displayed in the display DISP of the cellular phone is exemplified. A left screen shows that four E-mail Mail1-Mail4 reaches the user, and Mail2 and Mail4 are selected as print documents. This interface is provided by the mail server MS. When the user pushes the “iPrint” button on the screen, the execution request for printing is transmitted from the client MP to the mail server MS (refer to Sa01 in FIG. 3 and FIG. 2).

The installation of the “iPrint” button on the screen is permitted to the mail server MS registered in the print portal PP beforehand as a contents provider. This button functions as a link to the print portal PP. When the print is required with the “iPrint” button, the client MP is redirected to the print portal PP. After the redirection, a client information, which defines the client accessing the print portal PP, and print data, that is, Mail2 and Mail4, are transmitted from the mail server MS (refer to Sa02 in FIG. 3 and FIG. 2).

Print data, according to the client, may be forwarded from the mail server MS to the print portal PP with a certain format with security. At this time, the print portal PP controls the security unit SE2 according to the client information received, and receives the data. The method of sending and receiving data through the security unit is described below.

Next, the user interface, to specify the printer to be used and printing conditions, is provided to the client MP from the print portal PP (Sa03 in FIG. 3 and refer to FIG. 2). A normal method, by which the user selects the printer from a list, is described here.

The example of the user interface for the printer specification is shown at the center of FIG. 4. In the specification of a printer, the printing station available for the user is listed. The list may be displayed in a step by step manner. For instance, when the user selects “XX store” illustrated in FIG. 4, the mode branch may be listed. It is good to select a printing service provider not a printing station by the first hierarchy. The number of the hierarchy and branches listed by each hierarchy will increase when the number of optional printing stations is large.

The example of the interface to specify the printing conditions is shown at the left of FIG. 4. The printing conditions may include the size of printing paper, layout and resolution. Printing paper like A4 size and the B5 size, etc. can be set in detail by selecting the menu “printing paper”. A layout, such as one page/sheet and two page/sheet, etc., can be set in detail by selecting the menu “layout”. Other menus are also similar. Various items, other than those described above, can be set in the print setting to enhance the convenience of the system.

The new or modified print setting, including the printer to be used and the printing conditions, may be stored in the print portal PP or the client MP. When the user subsequently uses this system, the stored setting can be used, thereby making the operation simple.

When the user selects the printer and sets the printing conditions, this information is transmitted to the print portal PP through the security unit SE1 (refer to Sa04 in FIG. 3 and FIG. 2). The print portal PP provides security to this information according to the client and sends the data. During this communication, the print portal PP controls the security unit SE1 according to the client information previously received.

The print portal PP selects the printing service provider PSP1 based on the setting of the received printing settings referring to the printer to be used and the printing conditions, and forwards the print data through the security unit SE4 (refer to Sa07 in FIG. 3 and FIG. 2). The printing service provider PSP1 which manages the printing station PS11 specified by the user as an output device is selected as a destination to send the job.

The print data is transmitted through the security unit SE4. The print portal PP provides security to the data to be transmitted according to the client information previously received. Therefore, the data can be prevented from an illegal access and an outflow.

The printing service provider PSP1 which receives the print data selects the printing station PS11, and transmits the data (refer to Sa09 in FIG. 3 and FIG. 2). The printing station PS11 specified by the user is selected as the destination.

The print portal PP may convert the print data into PDF format by using the data conversion server before the print data is forwarded to the printing service provider PSP1 (refer to Sa05, Sa06 in FIG. 3 and FIG. 2). The data is sent and received through the security unit SE3 between the print portal PP and the data conversion server DT. Therefore, security can be provided according to the client based on the client information previously received. When the print portal PP forwards this PDF file to the printing service provider PSP1, etc., the printing station analyzes the received PDF file and executes printing.

The confirmation display of the printer to be used and the printing conditions may be provided to the client MP before forwarding the print data from the printing service provider PSP1 to the printing station PS11, as shown with Sa08 in FIG. 3. Moreover, the report of the print result can be transmitted from the printing station PS11 to the print portal PP after the print is completed (Sa10 of FIG. 3). This report enables the print portal PP to confirm the completion of the print without errors, and to do post processing, such as accounting, etc.

In this embodiment, two servers, the print portal PP and the printing service provider PSP1, relay the print data. The division of the server for the relay into two provides the following advantage.

The printing service provider can be installed according to a respective company, and that causes the respective company to keep their own service, thereby providing differences from those of other companies with regard to their business. It is also an advantage that each company can easily draw the user and contents provider, registered to the print portal and related to the other company, toward the company because the print portal is common to all companies.

Even when each printing service provider is related to different companies, the print portal can provide the user with a common user interface. Therefore, it causes the print portal to be more useful.

Moreover, after the registration to the print portal, the user can easily use various servers managed by the print portal. It causes the print portal to be useful because there is no necessity for performing a complex operation to register each printing service provider and each printing station. There is a similar profit for a contents provider. That is, once contents providers are registered in the print portal, they easily gain the user and the print station.

Of course, there is no necessity to construct a printing relay system with two servers, such as the print portal and the printing service provider. It can be constructed with a single server which has both the function of the print portal and the printing service provider.

C. Internal structure:

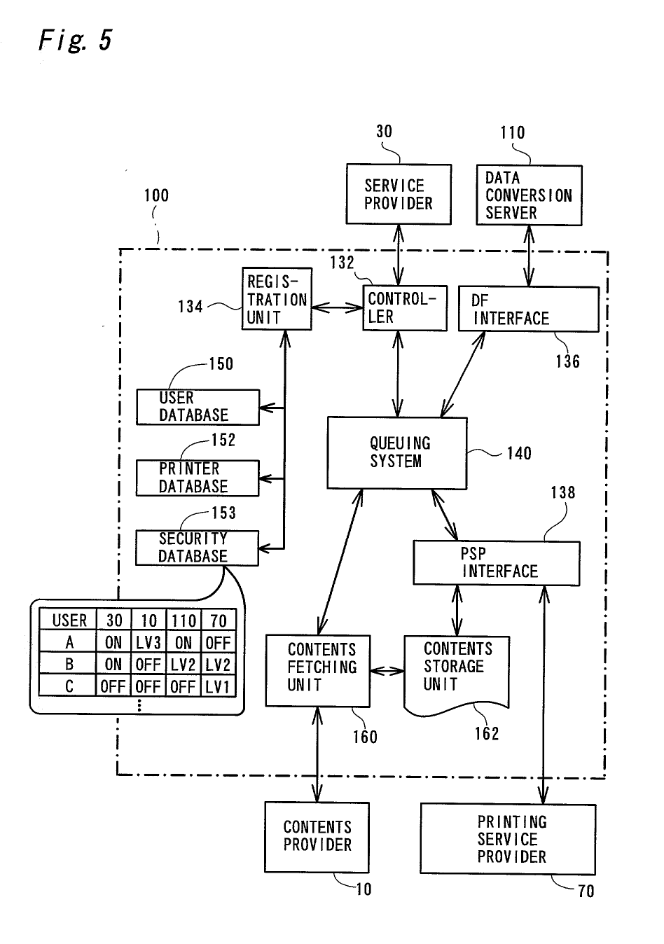

Next, an internal structure of the print portal is disclosed. FIG. 5 is a schematic that shows a detailed internal structure of the print portal. The function of each unit is the same as the unit of the same name in FIG. 1, though its index is different from FIG. 1 for convenience of explanation.

A controller 132 controls the operation of each functional block of the print portal 100 and the communication with external devices through the Internet. The control of the status of the print job, the acceptance and the cancellation of the printing request, and the retrieval of the printer to be selected as the output device, etc., are included in this control. The controller 132 also provides the user interface to instruct the print portal 100 to exchange various data with the external devices. In addition, the controller 132 executes the security control in the communication with the service provider 30.

The registration unit 134 registers and manages various information of the user of the print portal 100, the contents provider 10, and the printing service provider 70. The registration unit 134 generates user interfaces for the registration, stores and changes the data concerning the registration stored in the data base, and refers to the data base.

The queuing system 140 relays the instruction of each functional block. Each functional block detects the job to be processed based on the message registered in the queuing system 140, and executes each processing. When processing is completed, the message indicates the completion is registered in the queuing system 140. Thus, the print portal PP achieves a series of processing from the acceptance of the printing request to the completion of printing through the execution of each functional block by using the queuing system 140 as a relay unit.

Contents fetching queue, data conversion queue, job sending queue, job canceling queue, and security queue, etc., are prepared in the queuing system 140 to achieve a series of processing. The contents fetching unit 160 provides accessing to the contents provider 10, and fetches the contents specified by the user to be printed. Fetched contents are temporarily stored in the contents storage unit 162. The contents fetching unit 160 executes the above-mentioned operation according to the message included in the fetching queue stored in the queuing system 140. After the contents are fetched, the message requiring the data conversion of the contents is registered to the data conversion queue of the queuing system 140. Moreover, the contents fetching unit 160 executes the security control during the communication with the contents provider 10 based on the security queue. The content of the security queue is described below.

The data conversion server 110 provides a function to convert the contents into the PDF format. An advantage is provided that the output to various printers can be easily achieved by converting into the PDF format and relaying the print data in this format because PDF is a general format for various printers. Moreover, an advantage is provided that the layout of the printed matter can be maintained to be comparatively the same without regard to the printer. In addition, an advantage is provided that various contents can be printed because almost all of the print data, such as the document and the image, can be converted into PDF format. Various page description languages, such as Postscript (registered trademark), may be used as a general format.

The data conversion server 110 may be one of the function blocks in the print portal 100 when its function is provided by software. In this embodiment, the data conversion server 110 is constructed with the other server then the print portal 100, thereby reducing the load of each server. To transfer data between the data conversion server, the DF interface 136 is installed in the print portal 100.

The DF interface 136 passes the original data to the data conversion server 1 10 according to the message included in the data conversion queue stored in the queuing system 140. Moreover, when the PDF file converted by the data conversion server 110 is received, the DF interface 136 registers a send message of the print job in the job sending queue of the queuing system 140. Moreover, the DF interface 136 executes the security control during the communication with the data conversion server 110 based on the security queue.

The PSP interface 138 transmits the print job to the printing service provider 70. The PSP interface 13 8 transmits the print data to the printing service provider 70 according to the message stored in the job sending queue of the queuing system 140. The message of the job cancellation stored in the job canceling queue is transmitted as well. These transmissions are executed on various protocols, such as HTTP (Hypertext Transport Protocol), set by the printing service provider 70. Moreover, the PSP interface 138 executes the security control during the communication with the printing service provider 70 based on the security queue.

Various data bases, such as a user database 150, a printer database 152, and a security database 153, are prepared in the print portal 100. Various other data bases may be prepared in addition, and one relational database may be composed as though only three kinds of databases were illustrated here. These data bases are managed by the registration unit 134.

In the user database 150, files are prepared corresponding to each user of the print portal 100, to which the username and user ID, etc., are stored as attribute information corresponding to the user. Printer name and the identification number of each printer, etc., are registered in the printer database 152. The identification number is an index used to specify the printer in the printing through the print portal 100.

Information regarding which security should be provided to which apparatus is stored in the printer database 153 corresponding to each user. For instance, the security of user A is illustrated as follows; the security is on to the service provider 30 and the data conversion server 110; the security is off to the printing service provider 70; and the security is set at level 3 to the contents provider 10. When the level of security is high, that means that the security is strict. For instance, it is possible to change the security level by changing the number of bits used for the key data of an encryption.

The user may set the printer database 153 by oneself when the printing conditions is specified at Sa04 of FIG. 3, or the operator of the print portal 100 may decide the setting of the printer database 153.

The controller 132 registers the message in the security queue of the queuing system 140 by referring to this printer database 153. The controller 132, the DF interface 136, the contents fetching unit 160, and the PSP INTERFACE 138, which has the security control function (hereafter all of them being referred to as a security control unit) individually execute the security control based on this message during the communication with each external device.

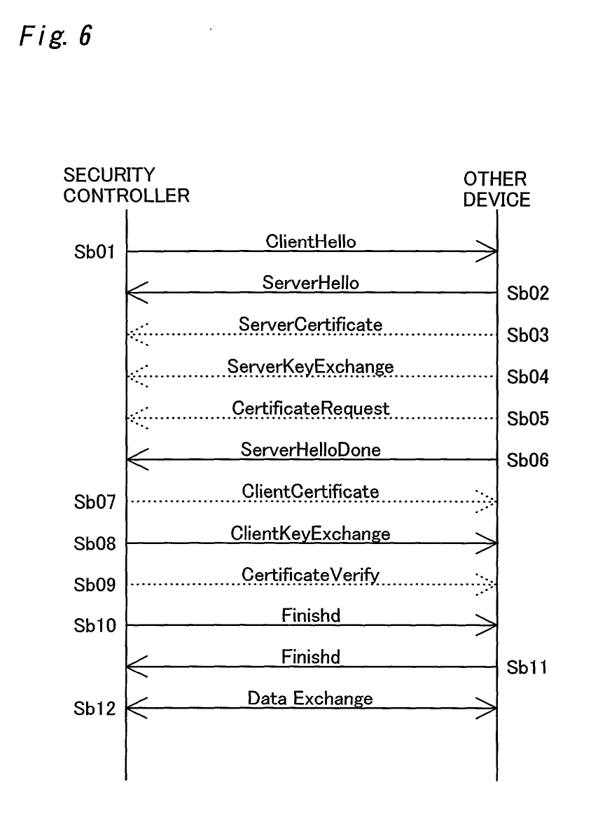

The security control to each external device which the security control unit executes is described. FIG. 6 is a chart that shows the processing of the security control, which is referred to as SSL (Secure Socket Layer) normally used in the Internet. SSL provides encryption, electric certification, and falsification prevention. In this embodiment, the security control using SSL is individually performed during the communication with each external device.

The security control unit transmits the encryption algorithm and the compressed algorithm, supported on the security control unit side (the print portal side), to the external device in ClientHello message Sb01 first. Afterwards, the external device specifies the encryption and compressed algorithms being supported by itself in ServerHello message Sb02.

Next, the external device transmits the public key proof data in ServerCertificate message Sb03. When the external device does not have the public key proof data, the public information of the external device, such as the RSA public key, is transmitted in SeverKeyExchange message Sb04. Next, the external device requires the presentation of the proof data to the security control unit in CertificateRequest message Sb05. ServerHelloDone message Sb05 means the end of the response, so the external device enters the waiting state afterwards.

When the ServerCertificate message is received from the external device, the security control unit transmits the suitable proof data for the request from the external device in ClientCertificate message Sb07. The connection is cut according to the setting of the external device when there is no proof data. Next, the security control unit transmits the data referred to as pre-master secret data to the external device in ClientKeyExchange message Sb08. Certificate Verify message Sb09 is transmitted when the security control unit receives ServerCertificate message Sb03, and is used for the verification of the public key proof data. After the verification, the security control unit and the external device mutually exchange Finishd message Sb10, Sb11, and confirm that the attestation has ended. After the attestation ends, the session key is finally generated based on the pre-master secret data. Data is encrypted by using this session key and mutually exchanged in DataExchange(Sb12). The message shown by dotted arrows in FIG. 6 is an option, and may be exchanged if necessary.

The method of security between the print portal and each external device is not limited to the above-mentioned SSL method, and various other methods, such as an attestation and encryption based on the user ID and the password, and a simple Caesar code, etc., are applicable. The security control unit can adjust the level of security by omitting the optional procedure in above-mentioned SSL method, in addition to the on/off control of the security.

Thus each security control unit can provide the appropriate security to each external device corresponding to the client individually. Unnecessary security being omitted, the overhead of data for the security can be reduced or minimized, and the amount of data on the network can be prevented from being increased. The load of the entire system can be decreased.

The above embodiments and their modifications are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein. For example, the series of control processes discussed above may be attained by the hardware construction, instead of the software configuration.

What is claimed is:

1. A data relay apparatus which intermediates between a client and an output device connected to a network, and relays data to the output device according to an instruction by the client, the data relay apparatus comprising:
a security unit configured to provide a security to each communication with plural external devices related to the relay;
a memory configured to keep a relation between the client and an operation of the security unit;
an identification unit configured to identify the client sending an access request to the data relay apparatus; and
a controller configured to control the security based on the relation corresponding to the identified client.

2. The data relay apparatus according to claim 1;
the external device including a data providing device configured to provide data at least responding to the request from the client.

3. The data relay apparatus according to claim 1;
the external device including at least a data conversion device configured to convert the data into another data format.

4. The data relay apparatus according to one of claim 1;
the security being a prescribed encryption.

5. The data relay apparatus according to one of claim 1;
the security being an electronic certification.

6. A data relay method which relays data to an output device according to an instruction from a client by using a data relay apparatus which intermediates between the client and the output device connected to a network, the data relay method comprising:
(a) setting a relation between the client and a security to be provided to each communication with plural external devices related to the relay;
(b) identifying the client sending an access request to the data relay apparatus; and
(c) controlling the security based on the relation corresponding to the client identified in step (b).

7. A computer readable recording medium storing a computer program which causes a data relay apparatus which intermediates between a client and an output device connected to a network to relay data to the output device according to an instruction from the client, the computer program causing the data relay apparatus to perform:
providing a security to each communication with plural external devices related to the relay;
storing a relation between the client and the security to be provided to each communication with plural external devices related to the relay;
identifying the client sending an access request to the data relay apparatus; and
controlling the security based on the relation corresponding to the identified client.
